(19) United States
(12) Patent Application Publication
(10) Pub. No.: US 2026/0084410 A1
(43) Pub. Date: Mar. 26, 2026

(54) Head Unit And Liquid Ejecting Apparatus

(71) Applicant: SEIKO EPSON CORPORATION, Tokyo (JP)

(72) Inventor: Ryuji FUJITA, Shiojiri (JP)

(21) Appl. No.: 19/339,468

(22) Filed: Sep. 25, 2025

(30) Foreign Application Priority Data
Sep. 26, 2024 (JP) 2024-167731

(51) Int. Cl. B41J 2/045; B41J 2/14; B41J 2/17

(52) U.S. Cl. CPC B41J 2/0451; B41J 2/04528; B41J 2/04541; B41J 2/04548; B41J 2/0455; B41J 2/04563; B41J 2/04581; B41J 2/04588; B41J 2/04593; B41J 2/14201; B41J 2/17; B41J 2002/14491

(57) ABSTRACT

A head unit includes: a head having a piezoelectric element which is displaced in response to application of a drive signal, and including an ejecting section which ejects ink in response to the displacement of the piezoelectric element; a heater that heats the ink; a temperature abnormality detection section that detects a temperature abnormality and outputs an abnormality detection signal; a heater stop section that stops an operation of the heater in response to the abnormality detection signal; and a head substrate coupled to the head, in which the heater stop section is mounted in an analog manner on the head substrate.

The present application is based on, and claims priority from JP Application Serial Number 2024-167731, filed Sep. 26, 2024, the disclosure of which is hereby incorporated by reference herein in its entirety.

### BACKGROUND

### 1. Technical Field

The present disclosure relates to a head unit and a liquid ejecting apparatus.

### 2. Related Art

In recent years, there has been an increasing demand for ink jet printers that use a heater to heat and eject highly viscous ink. In an ink jet printer that ejects highly viscous ink, as described in, for example, JP-A-2023-97687, a heater provided in a head unit is used to heat the ink and control its viscosity, thereby suppressing a decrease in image quality. When some abnormality causes current to continue to flow through the heater, the temperature of the head unit will rise and there is a concern of the head unit breaking down. Therefore, in the related art, a control unit on the main body side, located upstream from the head unit, acquires temperature information from the head unit and stops supplying current to the heater when a temperature abnormality has occurred.

However, when an abnormality occurs in the transmission of temperature information from the head unit to the control unit, there is a concern that the control unit will not be able to stop the current supply to the heater. In addition, in JP-A-2023-97687, a heater is used to control the temperature of an ink sub-tank provided in the vicinity of the head, but in order to heat the ink at a position closer to the head, it is preferable to provide a heater, for example, on a head substrate disposed above the head. However, the head substrate which is directly coupled to a piezoelectric element inside the head may be disposed in a very small area, making it difficult to mount an IC having a function of stopping the current to the heater in the limited area on the head substrate.

### SUMMARY

According to an aspect of the present disclosure, there is provided a head unit including: a head having a piezoelectric element which is displaced in response to application of a drive signal, and including an ejecting section which ejects ink in response to the displacement of the piezoelectric element; a heater that heats the ink; a temperature abnormality detection section that detects a temperature abnormality and outputs an abnormality detection signal; a heater stop section that stops an operation of the heater in response to the abnormality detection signal; and a head substrate coupled to the head, in which the heater stop section is mounted in an analog manner on the head substrate.

According to another aspect of the present disclosure, there is provided a liquid ejecting apparatus including: a head unit; and a power supply circuit, in which the head unit includes a head having a piezoelectric element which is displaced in response to application of a drive signal, and including an ejecting section which ejects ink in response to the displacement of the piezoelectric element, a heater that heats the ink, a temperature abnormality detection section that detects a temperature abnormality and outputs an abnormality detection signal, a heater stop section that stops an operation of the heater in response to the abnormality detection signal, and a head substrate coupled to the head, the power supply circuit outputs a heater drive signal for driving the heater, and the heater stop section is mounted in an analog manner on the head substrate.

### BRIEF DESCRIPTION OF THE DRAWINGS

FIG. 1 is a perspective view showing a schematic configuration of a liquid ejecting apparatus.

FIG. 2 is a block diagram showing an electrical configuration of the liquid ejecting apparatus.

FIG. 3 is a cross-sectional view showing a schematic configuration of an ejecting section.

FIG. 4 is a diagram showing an example of a drive signal.

FIG. 5 is a block diagram showing an electrical configuration of a drive signal selection circuit.

FIG. 6 is a circuit diagram showing an electrical configuration of a selection circuit.

FIG. 7 is a diagram showing decoding contents in a decoder.

FIG. 8 is a diagram for describing an operation of the drive signal selection circuit.

FIG. 9 is a diagram showing an example of a configuration of a temperature detection circuit.

FIG. 10 is a diagram showing an example of a configuration of a protection circuit in a first embodiment.

FIG. 11 is a plan view of a head substrate.

FIG. 12 is a diagram showing an example of a configuration of a protection circuit in a second embodiment.

FIG. 13 is a diagram showing an example of a configuration of a protection circuit in a third embodiment.

FIG. 14 is a diagram showing an example of a configuration of a protection circuit in a fourth embodiment.

FIG. 15 is a diagram showing another example of the configuration of the protection circuit in the fourth embodiment.

FIG. 16 is a diagram showing another example of the configuration of the protection circuit in the fourth embodiment.

### DESCRIPTION OF EMBODIMENTS

Hereinafter, preferred embodiments of the present disclosure will be described with reference to the drawings. The drawings used are for convenience of description. The embodiments to be described below do not unduly limit the contents of the present disclosure described in the scope of claims. Furthermore, not all of the configurations described below are necessarily essential constituent elements of the present disclosure.

### 1. First Embodiment

### 1-1. Configuration of Liquid Ejecting Apparatus

A printing apparatus, as an example of a liquid ejecting apparatus according to the present embodiment, is an ink jet printer that ejects ink in accordance with image data input from an external host computer to form dots on a print medium such as paper, and prints images including characters, figures, and the like in accordance with the image data.

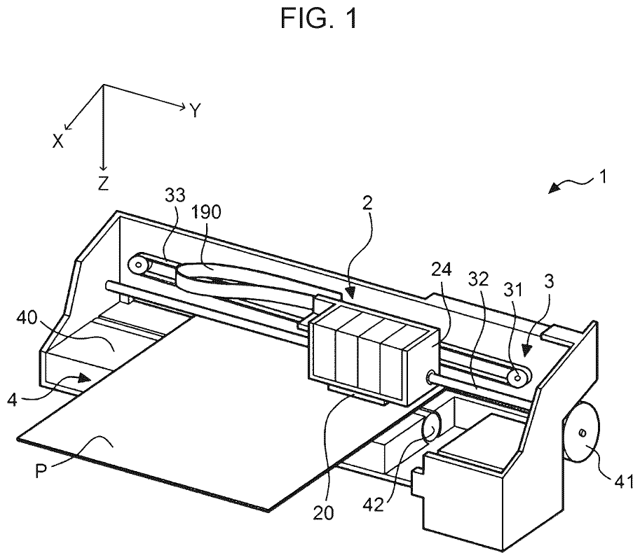

FIG. 1 is a perspective view showing a schematic configuration of a liquid ejecting apparatus 1. FIG. 1 shows a direction X in which a medium P is transported, a direction Y in which a moving object 2 reciprocates while intersecting the direction X, and a direction Z in which ink is ejected. In the present embodiment, the directions X, Y, and Z are described as axes orthogonal to each other, but the present disclosure is not limited to the fact that various configurations of the liquid ejecting apparatus 1 are disposed to be orthogonal to each other. In the following description, the direction Y in which the moving object 2 moves may be referred to as a main scanning direction.

As shown in FIG. 1, the liquid ejecting apparatus 1 includes the moving object 2 and a moving mechanism 3 that reciprocates the moving object 2 in the direction Y. The moving mechanism 3 includes a carriage motor 31 serving as a drive source of the moving object 2, a carriage guide shaft 32 having both ends fixed, and a timing belt 33 that extends substantially parallel to the carriage guide shaft 32 and is driven by the carriage motor 31.

The carriage 24 included in the moving object 2 is supported by a carriage guide shaft 32 to be able to reciprocate and is fixed to a portion of the timing belt 33. The carriage 24 is guided by the carriage guide shaft 32 and reciprocates in the direction Y by driving the timing belt 33 with the carriage motor 31. Furthermore, a head unit 20 having a large number of nozzles is provided in the portion of the moving object 2 that faces the medium P. A control signal or the like is input to the head unit 20 via a cable 190. The head unit 20 ejects ink which is an example of a liquid from the nozzles based on the control signal which is input.

The liquid ejecting apparatus 1 includes a transport mechanism 4 that transports the medium P on the platen 40 in the direction X. The transport mechanism 4 includes a transport motor 41 that is a drive source, and a transport roller 42 that is rotated by the transport motor 41 to transport the medium P in the direction X.

In the liquid ejecting apparatus 1 configured as above, an image is formed at the surface of the medium P by the head unit 20 ejecting ink at the timing when the medium P is transported by the transport mechanism 4.

### 1-2. Electrical Configuration of Liquid Ejecting Apparatus

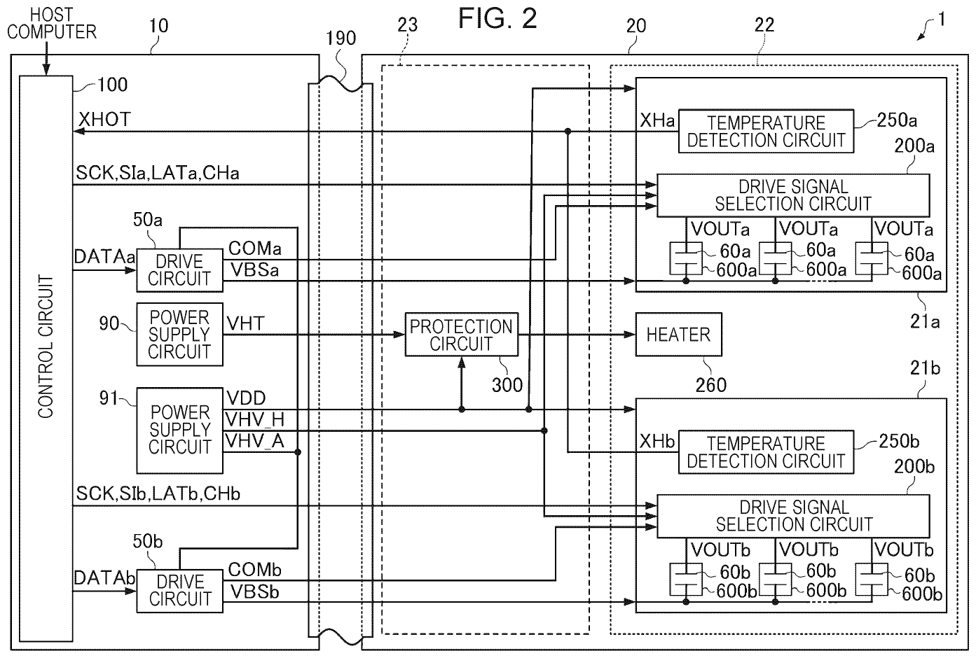

FIG. 2 is a block diagram showing an electrical configuration of the liquid ejecting apparatus 1. As shown in FIG. 2, the liquid ejecting apparatus 1 has a control unit 10 and the head unit 20. The control unit 10 and the head unit 20 are electrically coupled via the cable 190 such as a flexible flat cable (FFC).

The control unit 10 includes a control circuit 100, power supply circuits 90 and 91, and drive circuits 50a and 50b. Then, the control circuit 100 generates a plurality of control signals and the like for controlling various configurations based on image data input from the host computer, and outputs the control signals to the head unit 20.

Specifically, the control circuit 100 outputs, to the head unit 20, a clock signal SCK, print data signals SIa and SIb, latch signals LATa and LATb, and change signals CHa and CHb. Further, the control circuit 100 outputs drive data signals DATAa and DATAb to the drive circuits 50a and 50b, respectively.

Also, although not shown, the control circuit 100 controls the carriage motor 31 and the transport motor 41. Accordingly, the movement of the carriage 24 in the direction Y of the carriage 24 shown in FIG. 1 and the movement of the medium P in the direction X shown in FIG. 1 are controlled.

The power supply circuit 90 generates a heater drive signal VHT, and supplies the heater drive signal VHT to a protection circuit 300 included in the head unit 20. The heater drive signal VHT is a signal that drives a heater 260 included in the head unit 20.

The power supply circuit 91 generates voltages VHV_H and VHV_A of, for example, DC 42 V. Then, the power supply circuit 91 supplies the voltage VHV_H to a print head 22 included in the head unit 20, and supplies the voltage VHV_A to the drive circuits 50a and 50b. In addition, the power supply circuit 91 generates a voltage VDD, and supplies the voltage VDD to liquid ejecting modules 21a and 21b and the protection circuit 300 included in the head unit 20.

The drive circuit 50a generates a drive signal COMa and a reference voltage signal VBSa based on the voltage VHV_A and the drive data signal DATAa, and outputs the signals to the head unit 20. Furthermore, the drive circuit 50b generates a drive signal COMb and a reference voltage signal VBSb based on the voltage VHV_A and the drive data signal DATAb, and outputs the signals to the head unit 20. Here, the reference voltage signals VBSa and VBSb are constant voltage signals, and are, for example, voltage signals of a ground potential, DC 5 V, DC 6 V, or the like.

The head unit 20 includes the print head 22, a head substrate 23 coupled to the print head 22, and the protection circuit 300. The print head 22 includes the liquid ejecting modules 21a and 21b.

The liquid ejecting module 21a has a drive signal selection circuit 200a, a plurality of ejecting sections 600a, and a temperature detection circuit 250a. Furthermore, each ejecting section 600a includes a piezoelectric element 60a. The drive signal selection circuit 200a receives the clock signal SCK, the print data signal SIa, the latch signal LATa, the change signal CHa, the drive signal COMa, and the voltage VHV_H as inputs. The drive signal selection circuit 200a generates a drive signal VOUTa by selecting or deselecting the drive signal COMa based on the clock signal SCK, the print data signal SIa, the latch signal LATa, the change signal CHa, and the voltage VHV_H.

The drive signal VOUTa is supplied to one end of the piezoelectric element 60a included in each of the plurality of ejecting sections 600a. The other end of the piezoelectric element 60a is supplied with the reference voltage signal VBSa. The piezoelectric element 60a is driven by a potential difference between the drive signal VOUTa and the reference voltage signal VBSa, thereby causing ink to be ejected from the ejecting section 600a. That is, the liquid ejecting module 21a has the piezoelectric element 60a that is driven by the drive signal COMa, and the drive signal selection circuit 200a that controls the supply of the drive signal COMa to the piezoelectric element 60a.

The temperature detection circuit 250a detects the temperature of the print head 22 and determines whether or not the temperature is equal to or higher than a predetermined threshold value. When the temperature of the print head 22 is equal to or higher than a predetermined threshold value, the temperature detection circuit 250a determines that a temperature abnormality has occurred in the print head 22, and outputs an L level temperature abnormality signal XHa indicating that the temperature of the print head 22 is abnormal.

The liquid ejecting module 21b has a drive signal selection circuit 200b, a plurality of ejecting sections 600b, and a temperature detection circuit 250b. Furthermore, each ejecting section 600b includes a piezoelectric element 60b. The drive signal selection circuit 200b receives the clock signal SCK, the print data signal SIb, the latch signal LATb, the change signal CHb, the drive signal COMb, and the voltage VHV_H as inputs. The drive signal selection circuit 200b generates a drive signal VOUTb by selecting or deselecting the drive signal COMb based on the clock signal SCK, the print data signal SIb, the latch signal LATb, the change signal CHb, and the voltage VHV_H.

The drive signal VOUTb is supplied to one end of the piezoelectric element 60b included in each of the plurality of ejecting sections 600b. The other end of the piezoelectric element 60b is supplied with the reference voltage signal VBSb. The piezoelectric element 60b is driven by a potential difference between the drive signal VOUTb and the reference voltage signal VBSb, thereby causing ink to be ejected from the ejecting section 600b. That is, the liquid ejecting module 21b has the piezoelectric element 60b that is driven by the drive signal COMb, and the drive signal selection circuit 200b that controls the supply of the drive signal COMb to the piezoelectric element 60b.

The temperature detection circuit 250b detects the temperature of the print head 22 and determines whether or not the temperature is equal to or higher than a predetermined threshold value. When the temperature of the print head 22 is equal to or higher than a predetermined threshold value, the temperature detection circuit 250b determines that a temperature abnormality has occurred in the print head 22, and outputs an L level temperature abnormality signal XHb indicating that the temperature of the print head 22 is abnormal.

In the head substrate 23, a wiring through which the temperature abnormality signal XHa propagates and a wiring through which the temperature abnormality signal XHb propagates are coupled to form a single wiring, and the temperature abnormality signals XHa and XHb are integrated into a temperature abnormality signal XHOT, which is input to the control circuit 100 of the control unit 10. When at least one of the temperature abnormality signal XHa and the temperature abnormality signal XHb is at L level, the temperature abnormality signal XHOT is at L level, and when the temperature abnormality signal XHa and the temperature abnormality signal XHb are at H level, the temperature abnormality signal XHOT is at H level. When the temperature abnormality signal XHOT becomes L level, the control circuit 100 stops outputting the clock signal SCK, the print data signals SIa and SIb, the latch signals LATa and LATb, and the change signals CHa and CHb, and stops outputting the voltages VHV_H, VHV_A, and VHT from the power supply circuit 91. Note that the temperature abnormality signals XHa and XHb may be input to the control circuit 100 separately without being integrated.

In the following description, the drive circuits 50a and 50b have the same configuration, and may be referred to as the drive circuit 50 unless there is a particular need to distinguish between the drive circuits 50a and 50b. The various signals input to the drive circuit 50 are referred to as the voltage VHV_H and the drive data signal DATA. Moreover, the various signals output from the drive circuit 50 are referred to as the drive signal COM and the reference voltage signal VBS.

Moreover, the liquid ejecting modules 21a and 21b have the same configuration, and are referred to as the liquid ejecting module 21 unless there is a particular need to distinguish between the liquid ejecting modules 21a and 21b. Further, the liquid ejecting module 21 has a drive signal selection circuit 200, a plurality of ejecting sections 600, and a temperature detection circuit 250, and the description will be given assuming that the plurality of ejecting sections 600 includes a piezoelectric element 60. In this case, the various signals input to the liquid ejecting module 21 are referred to as the clock signal SCK, the print data signal SI, the latch signal LAT, the change signal CH, the drive signal COM, the reference voltage signal VBS, and the voltage VHV_H. In addition, the signal supplied to the piezoelectric element 60 is referred to as a drive signal VOUT. Moreover, the signal output from the temperature detection circuit 250 is referred to as a temperature abnormality signal XH.

The heater 260 generates heat when the heater drive signal VHT is supplied, and heats the ink supplied to each ejecting section 600a of the liquid ejecting module 21a and each ejecting section 600b of the liquid ejecting module 21b. For example, the heater 260 includes a plurality of heating elements coupled in series between a supply line of the heater drive signal VHT and ground, and generates heat when a current flows through the plurality of heating elements in response to the heater drive signal VHT. For example, the heating element is a resistor. For example, the heater 260 is provided in the print head 22.

The protection circuit 300 receives the heater drive signal VHT as an input, and controls the supply of the heater drive signal VHT to the heater 260 depending on whether or not there is an abnormality in the temperature of the head unit 20. Specifically, the protection circuit 300 supplies the heater drive signal VHT to the heater 260 when the temperature of the head unit 20 is normal. Furthermore, the protection circuit 300 stops the supply of the heater drive signal VHT to the heater 260, when an abnormality in the temperature of the head unit 20 is detected. As will be described later, at least a portion of the protection circuit 300 is mounted on the head substrate 23.

### 1-3. Configuration of Ejecting Section

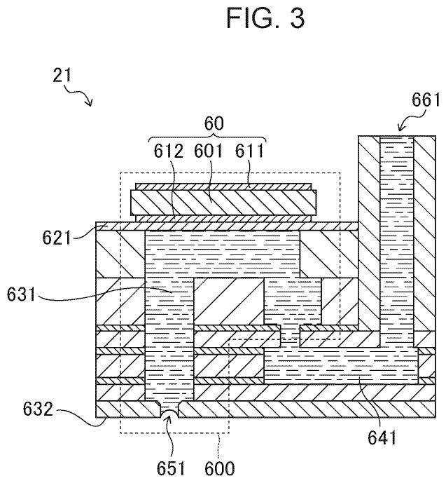

Next, the configuration and the operation of the ejecting section 600 including the piezoelectric element 60 will be described with reference to FIG. 3. FIG. 3 is a cross-sectional view showing a schematic configuration of the ejecting section 600 when the liquid ejecting module 21 is cut to include the ejecting section 600.

As shown in FIG. 3, the liquid ejecting module 21 includes an ejecting section 600 and a reservoir 641. Ink is introduced into the reservoir 641 from a supply port 661. In addition, the reservoir 641 is provided for each color of ink.

The ejecting section 600 includes a piezoelectric element 60, a vibration plate 621, a cavity 631, and a nozzle 651. The vibration plate 621 is provided between the cavity 631 and the piezoelectric element 60. The vibration plate 621 is displaced by driving the piezoelectric element 60 provided on the upper surface thereof. That is, the vibration plate 621 functions as a diaphragm that expands/reduces the internal volume of the cavity 631 by being displaced. The inside of the cavity 631 is filled with ink. Furthermore, the cavity 631 functions as a pressure chamber in which the internal volume changes by driving the piezoelectric element 60. The nozzle 651 is an opening portion which is provided on the nozzle plate 632 and communicates with the cavity 631.

The piezoelectric element 60 has a structure in which a piezoelectric body 601 is interposed between a pair of electrodes 611 and 612. The drive signal VOUT is supplied to the electrode 611, and the reference voltage signal VBS is supplied to the electrode 612. The piezoelectric element 60 having such a structure is driven according to a potential difference between the electrodes 611 and 612. As the piezoelectric element 60 is driven, the electrodes 611 and 612 and the central portion of the vibration plates 621 are displaced vertically with respect to both end portions. Then, the internal volume of the cavity 631 changes with the displacement of the vibration plate 621, and the ink filled in the cavity 631 is ejected from the nozzle 651.

Here, the drive signal VOUT is a signal in which at least a portion of the drive signal COM is selected, the piezoelectric element 60 is displaced in response to the application of the drive signal COM, and the ejecting section 600 ejects ink onto the medium P in response to the displacement of the piezoelectric element 60.

### 1-4. Configuration of Drive Signal Selection Circuit

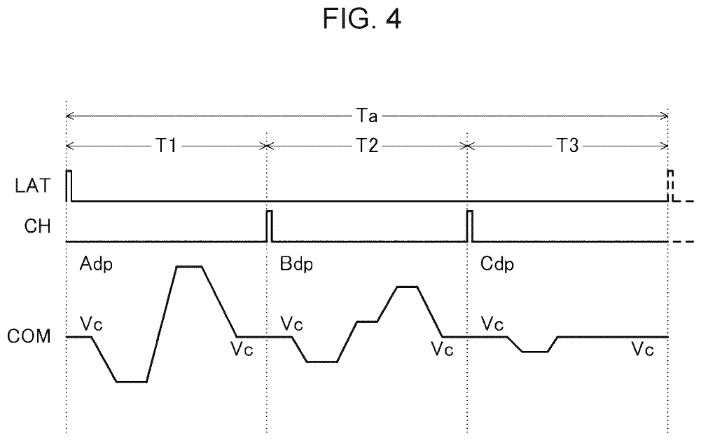

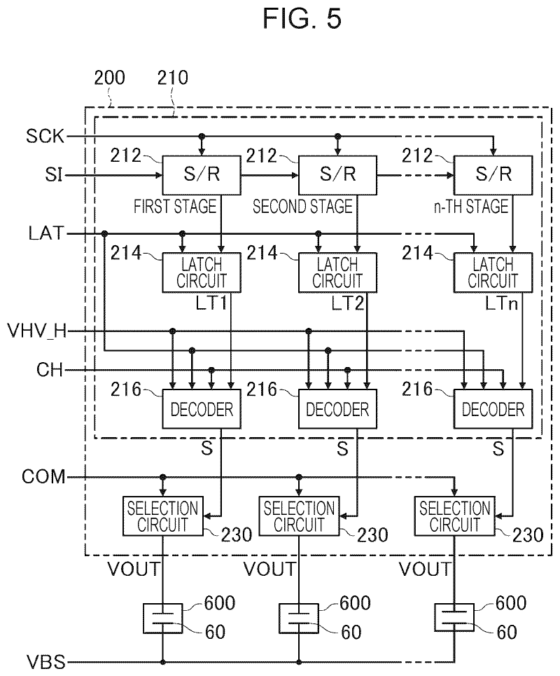

Next, the configuration and the operation of the drive signal selection circuit 200 will be described. In describing the configuration and the operation of the drive signal selection circuit 200, first, an example of the drive signal COM input to the drive signal selection circuit 200 will be described with reference to FIG. 4. Then, the configuration and the operation of the drive signal selection circuit 200 will be described with reference to FIGS. 5 to 8.

FIG. 4 is a diagram showing an example of the drive signal COM. FIG. 4 shows a period T1 from a rise of the latch signal LAT to a rise of the change signal CH, a period T2 from the period T1 to a next rise of the change signal CH, and a period T3 from the period T2 to a rise of the latch signal LAT. Then, the cycle formed by the periods T1, T2, and T3 is a cycle Ta for forming new dots on the medium P. That is, as shown in FIG. 4, the latch signal LAT defines the cycle in which a new dot is formed at the medium P, and the change signal CH defines a switch timing of a waveform included in the drive signal COM.

As shown in FIG. 4, the drive circuit 50 generates a trapezoidal waveform Adp in the period T1. When the trapezoidal waveform Adp is supplied to the piezoelectric element 60, a predetermined amount, specifically, a medium amount of ink is ejected from the corresponding ejecting section 600. In addition, the drive circuit 50 generates a trapezoidal waveform Bdp in the period T2. When the trapezoidal waveform Bdp is supplied to the piezoelectric element 60, a small amount of ink smaller than the predetermined amount is ejected from the corresponding ejecting section 600. Further, the drive circuit 50 generates a trapezoidal waveform Cdp in the period T3. When the trapezoidal waveform Cdp is supplied to the piezoelectric element 60, the piezoelectric element 60 is driven to such an extent that ink is not ejected from the corresponding ejecting section 600. Therefore, when the trapezoidal waveform Cdp is supplied to the piezoelectric element 60, dots are not formed at the medium P. The trapezoidal waveform Cdp performs micro-vibration of ink near a nozzle opening portion of the ejecting section 600 to prevent the viscosity of the ink from increasing. In the following description, driving the piezoelectric element 60 to such an extent that ink is not ejected from the ejecting section 600 in order to prevent the viscosity of the ink from increasing is referred to as “micro-vibration”.

Here, a voltage value at a start timing and a voltage value at an end timing of each of the trapezoidal waveform Adp, the trapezoidal waveform Bdp, and the trapezoidal waveform Cdp are all common to each other and are all the voltage Vc. That is, the trapezoidal waveforms Adp, Bdp, and Cdp are waveforms that start at the voltage Vc and end at the voltage Vc. Therefore, the drive circuit 50 outputs a drive signal COM having a waveform in which the trapezoidal waveforms Adp, Bdp, and Cdp are continuous in the cycle Ta. Note that the waveform of the drive signal COM shown in FIG. 4 is merely an example, and the waveform of the drive signal COM may be a different waveform. Further, the drive circuits 50a and 50b may generate and output drive signals COM having different waveforms.

FIG. 5 is a block diagram showing an electrical configuration of the drive signal selection circuit 200. The drive signal selection circuit 200 switches whether or not to select the trapezoidal waveforms Adp, Bdp, and Cdp included in the drive signal COM in each of the cycles T1, T2, and T3, thereby, generating and outputting the drive signal VOUT to be supplied to the piezoelectric element 60 in the period Ta. As shown in FIG. 5, the drive signal selection circuit 200 includes a selection control circuit 210 and a plurality of selection circuits 230.

The selection control circuit 210 is supplied with the clock signal SCK, the print data signal SI, the latch signal LAT, the change signal CH, and the voltage VHV_H. The selection control circuit 210 is provided with a set of a shift register 212 (S/R), a latch circuit 214, and a decoder 216 corresponding to each of the ejecting sections 600. That is, the head unit 20 is provided with sets of shift registers 212, latch circuits 214, and decoders 216, the number of which is the same as the total number n of the ejecting sections 600.

The shift register 212 temporarily holds 2-bit print data [SIH, SIL] included in the print data signal SI for each corresponding ejecting section 600. More specifically, the shift registers 212 of the number of stages corresponding to the number of ejecting sections 600 are coupled in cascade with each other, and the print data signal SI supplied in serial is sequentially transferred to the subsequent stages in accordance with the clock signal SCK. In FIG. 5, in order to distinguish between the shift registers 212, a first stage, a second stage, . . . , and an n-th stage are described in order from the upstream to which the print data signal SI is supplied.

Each of the n latch circuits 214 latches the print data [SIH, SIL] held by the corresponding shift register 212 at a rising edge of the latch signal LAT. Each of the n decoders 216 decodes the 2-bit print data [SIH, SIL] latched by the corresponding latch circuit 214 to generate a selection signal S, and supplies the selection signal S to the selection circuit 230.

The selection circuit 230 is provided corresponding to each of the ejecting sections 600. That is, the number of selection circuits 230 that one head unit 20 has is the same as the total number n of ejecting sections 600 included in the head unit 20. The selection circuit 230 controls the supply of the drive signal COM to the piezoelectric element 60 based on the selection signal S supplied from the decoder 216.

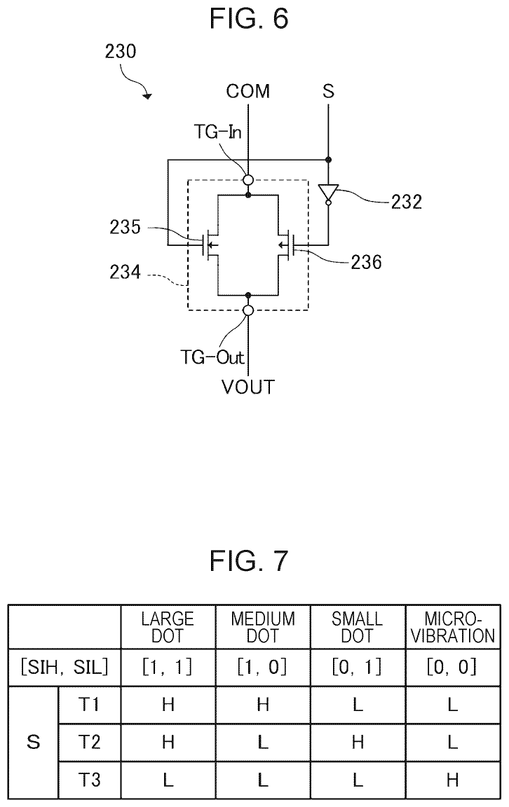

FIG. 6 is a circuit diagram showing an electrical configuration of the selection circuit 230 corresponding to one ejecting section 600. As shown in FIG. 6, the selection circuit 230 has an inverter 232 and a transfer gate 234. In addition, the transfer gate 234 includes a transistor 235 which is an NMOS transistor and a transistor 236 which is a PMOS transistor.

The selection signal S is supplied from the decoder 216 to a gate terminal of the transistor 235. In addition, the selection signal S is logically inverted by the inverter 232 and is also supplied to a gate terminal of the transistor 236. A drain terminal of the transistor 235 and a source terminal of the transistor 236 are coupled to one end, that is, a terminal TG-In. A drive signal COM is input from the terminal TG-In. The transistor 235 and the transistor 236 are controlled to be turned on or off in accordance with a selection signal S, thereby outputting a drive signal VOUT from a terminal TG-Out which is the other end to which a source terminal of the transistor 235 and a drain terminal of the transistor 236 are commonly coupled. The terminal TG-Out is electrically coupled to an electrode 611 of the piezoelectric element 60, which will be described later. In the following description, when the transistor 235 and the transistor 236 are controlled to be in a conductive state, this may be referred to as being on, and when the transistor 235 and the transistor 236 are controlled to be in a non-conductive state, this may be referred to as being off.

Next, the decoding contents of the decoder 216 will be described with reference to FIG. 7. FIG. 7 is a diagram showing decoding contents in the decoder 216. The decoder 216 receives the 2-bit print data [SIH, SIL], the latch signal LAT, and the change signal CH. For example, when the print data [SIH, SIL] is [1, 0] defining a “medium dot”, the decoder 216 outputs the selection signal S which becomes H level, L level, and L level in the periods T1, T2, and T3. Here, the logic level of the selection signal S is level-shifted to a high-amplitude logic based on the voltage VHV_H by a level shifter (not shown).

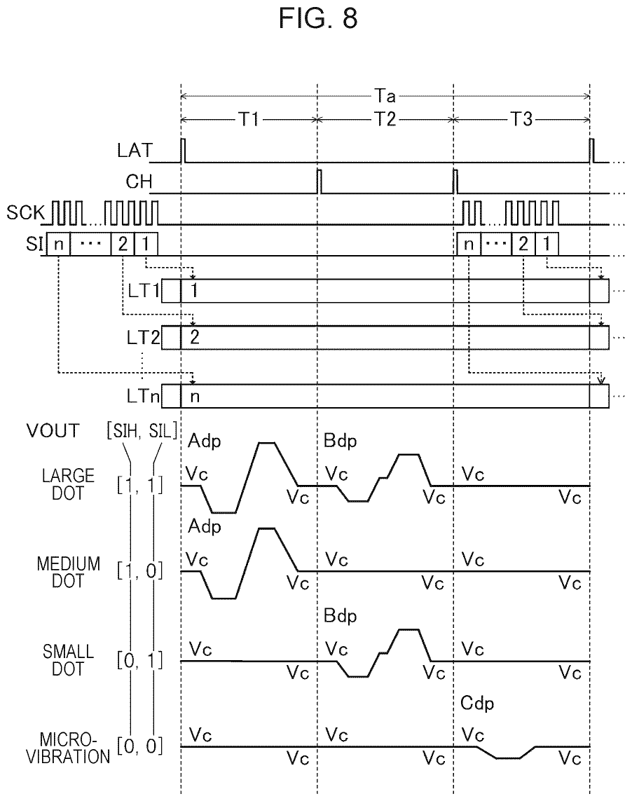

FIG. 8 is a diagram for describing the operation of the drive signal selection circuit 200. As shown in FIG. 8, the print data signal SI is serially supplied to the drive signal selection circuit 200 in synchronization with the clock signal SCK, and is sequentially transferred in the shift registers 212 corresponding to the ejecting sections 600. When the supply of the clock signal SCK is stopped, the print data [SIH, SIL] corresponding to the ejecting section 600 is held in each of the shift registers 212. The print data signal SI is supplied in the order corresponding to a last n-th stage ejecting section 600, . . . , a second stage ejecting section 600, and a first stage ejecting section 600 in the shift register 212.

Here, when the latch signal LAT rises, each of the latch circuits 214 simultaneously latches the print data [SIH, SIL] held in the corresponding shift register 212. LT1, LT2, . . . , LTn shown in FIG. 8 are the print data [SIH, SIL] latched by the latch circuits 214 corresponding to a first stage shift registers 212, a second stage shift registers 212, . . . , and an n-th stage shift registers 212.

The decoder 216 outputs the selection signal S having a logic level according to the content shown in FIG. 7 in each of the periods T1, T2, and T3 according to the dots size defined by the latched print data [SIH, SIL].

When the print data [SIH, SIL] is [1, 1], the selection circuit 230 selects the trapezoidal waveform Adp in the period T1, selects the trapezoidal waveform Bdp in the period T2, and does not select the trapezoidal waveform Cdp in the period T3, according to the selection signal S. As a result, the drive signal VOUT corresponding to the large dot shown in FIG. 8 is generated. Therefore, a medium amount of ink and a small amount of ink are ejected from the ejecting section 600. Therefore, the inks combine to form large dots at the medium P. In addition, when the print data [SIH, SIL] is [1, 0], according to the selection signal S, the selection circuit 230 selects the trapezoidal waveform Adp in the period T1, does not select the trapezoidal waveform Bdp in the period T2, and does not select the trapezoidal waveform Cdp in the period T3. As a result, the drive signal VOUT corresponding to a medium dot shown in FIG. 8 is generated. Therefore, a medium amount of ink is ejected from the ejecting section 600. Therefore, medium dots are formed at the medium P. In addition, when the print data [SIH, SIL] is [0, 1], according to the selection signal S, the selection circuit 230 does not select the trapezoidal waveform Adp in the period T1, selects the trapezoidal waveform Bdp in the period T2, and does not select the trapezoidal waveform Cdp in the period T3. As a result, the drive signal VOUT corresponding to the small dot shown in FIG. 8 is generated. Therefore, a small amount of ink is ejected from the ejecting section 600. Accordingly, a small dot is formed at the medium P. In addition, when the print data [SIH, SIL] is [0, 0], according to the selection signal S, the selection circuit 230 does not select the trapezoidal waveform Adp in the period T1, does not select the trapezoidal waveform Bdp in the period T2, and selects the trapezoidal waveform Cdp in the period T3. As a result, the drive signal VOUT corresponding to micro-vibration shown in FIG. 8 is generated. Therefore, ink is not ejected from the ejecting section 600, and the micro-vibration is generated.

### 1-5. Configuration of Temperature Detection Circuit

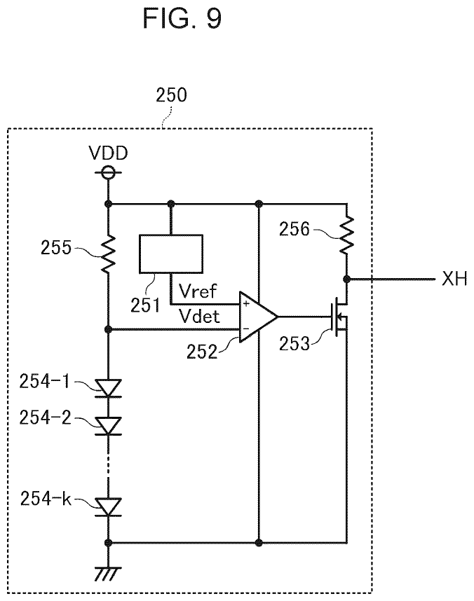

Next, the configuration and the operation of the temperature detection circuit 250 will be described. FIG. 9 is a diagram showing an example of the configuration of the temperature detection circuit 250. As shown in FIG. 9, the temperature detection circuit 250 includes a reference voltage generation circuit 251, a comparator 252, a transistor 253, diodes 254-1 to 254-k, and resistors 255 and 256. In addition, the temperature detection circuit 250 is supplied with the voltage VDD.

The voltage VDD is input to the reference voltage generation circuit 251, one end of the resistor 255, and one end of the resistor 256. The reference voltage generation circuit 251 transforms the voltage VDD to generate a voltage Vref having a constant voltage value. The voltage Vref generated by the reference voltage generation circuit 251 is input to the positive input terminal of the comparator 252. The other end of the resistor 255 is electrically coupled to the anode terminal of the diode 254-1. The cathode terminal of the diode 254-i (i is any of 1 to k−1) is electrically coupled to the anode terminal of the diode 254-(i+1). In addition, the cathode terminal of the diode 254-k is coupled to the ground. That is, the diodes 254-1 to 254-k are coupled in series between the other end of the resistor 255 and the ground.

The voltage at the coupling point where the other end of the resistor 255 and the anode terminal of the diode 254-1 are coupled is input to the negative input terminal of the comparator 252 as a voltage Vdet. The voltage at this coupling point is the sum of the forward voltages of the diodes 254-1 to 254-k. When the temperature rises, the forward voltage of each of the diodes 254-1 to 254-k decreases, and therefore the voltage Vdet decreases.

The comparator 252 compares the voltage Vref input to the positive input terminal with the voltage Vdet input to the negative input terminal. When the voltage Vdet is greater than the voltage Vref, the comparator 252 outputs an L level signal of the ground potential, and when the voltage Vdet is smaller than the voltage Vref, the comparator 252 outputs an H level signal of the voltage VDD.

The output terminal of the comparator 252 is coupled to a gate terminal of the transistor 253. The transistor 253 is an N-channel MOS transistor, a drain terminal of the transistor 253 is coupled to the other end of the resistor 256, and a source terminal of the transistor 253 is coupled to the ground. The signal at the drain terminal of the transistor 253 is output from the temperature detection circuit 250 as the temperature abnormality signal XH.

When an L level signal is input to the gate terminal of the transistor 253, a non-conductive state is created between the drain terminal and the source terminal. Accordingly, the voltage of the drain terminal of the transistor 253 is pulled up by the resistor 256, and the temperature detection circuit 250 outputs an H level temperature abnormality signal XH. On the other hand, when an H level signal is input to the gate terminal of the transistor 253, a conductive state is created between the drain terminal and the source terminal. Accordingly, the voltage of the drain terminal of the transistor 253 becomes the ground potential, and the temperature detection circuit 250 outputs an L level temperature abnormality signal XH. That is, the temperature detection circuit 250 outputs an H level temperature abnormality signal XH when the temperature is within a predetermined range, and outputs an L level temperature abnormality signal XH when the temperature exceeds the predetermined range.

### 1-6. Configuration of Protection Circuit

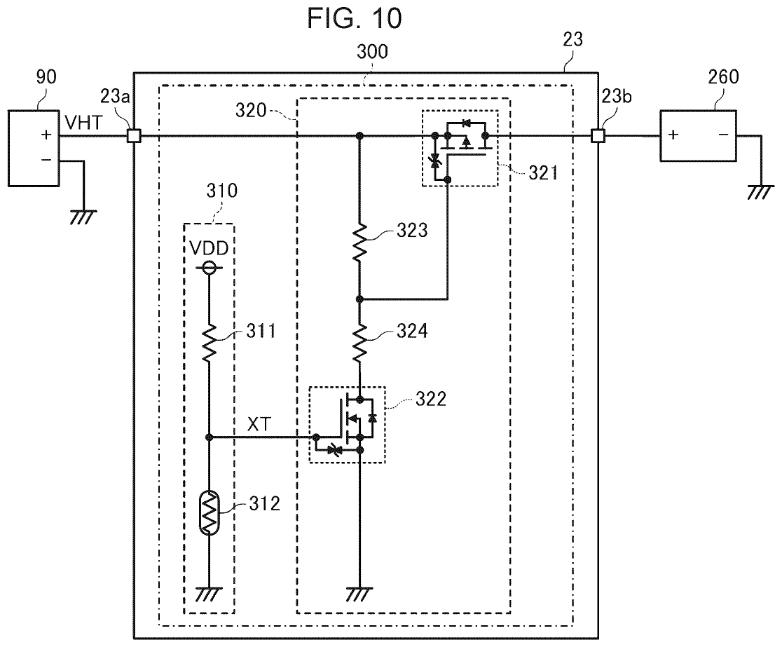

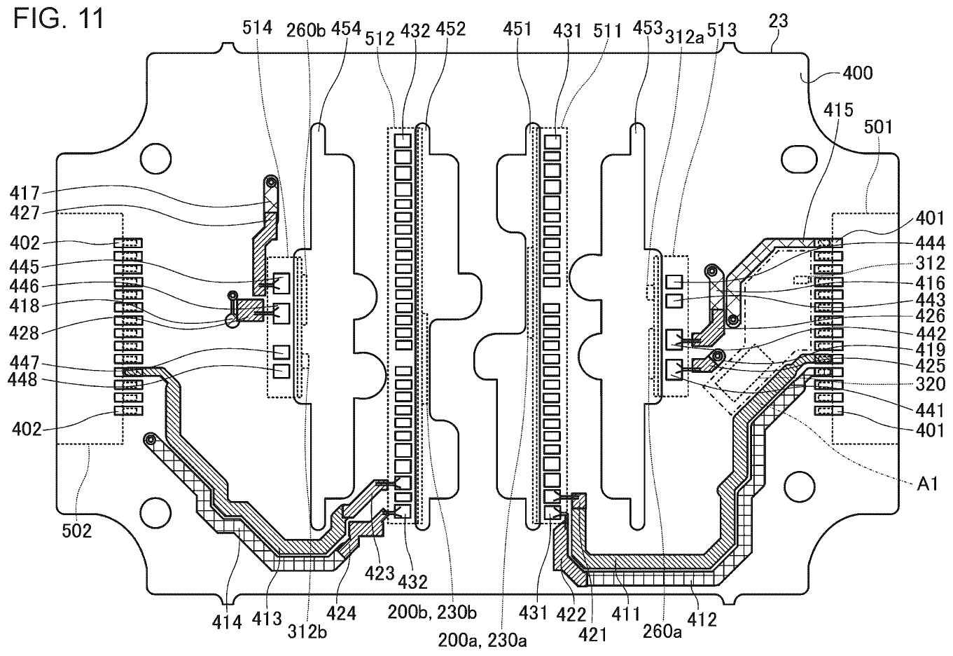

Next, the configuration and the operation of the protection circuit 300 will be described. FIG. 10 is a diagram showing an example of the configuration of the protection circuit 300. In FIG. 10, the power supply circuit 90, the head substrate 23, and the heater 260 are also shown.

As shown in FIG. 10, the head substrate 23 has terminals 23a and 23b. The terminal 23a is coupled to a positive terminal of the power supply circuit 90 and is a power supply terminal to which a heater drive signal VHT for driving the heater 260 is input. The terminal 23b is a terminal that is coupled to a positive terminal of the heater 260. A negative terminal of the heater 260 is coupled to ground.

As shown in FIG. 10, the protection circuit 300 includes a temperature abnormality detection section 310 and a heater stop section 320.

The temperature abnormality detection section 310 includes a resistor 311 and a thermistor 312.

The resistor 311 has one end to which the voltage VDD is supplied, and the other end to which one end of the thermistor 312 is coupled. The other end of the thermistor 312 is coupled to ground. A signal at a coupling point where the other end of the resistor 311 and one end of the thermistor 312 are coupled is output to the heater stop section 320 as an abnormality detection signal XT. In this manner, the temperature abnormality detection section 310 detects a temperature abnormality using the resistor 311 and thermistor 312, and outputs an abnormality detection signal XT. The thermistor 312 is an NTC thermistor, and the higher the temperature, the lower the resistance value of thermistor 312. Therefore, the higher the temperature, the lower the voltage of the abnormality detection signal XT.

The heater stop section 320 includes a P-channel transistor 321, an N-channel transistor 322, a resistor 323, and a resistor 324. For example, the transistor 321 is a P-channel field effect transistor (FET), and the transistor 322 is an N-channel FET.

A drain terminal of the transistor 321 is coupled to the positive terminal of the heater 260, and a source terminal of the transistor 321 is coupled to the terminal 23a of the head substrate 23. The resistor 323 has one end coupled to the source terminal of the transistor 321 and the other end coupled to a gate terminal of the transistor 321. The resistor 324 has one end coupled to the gate terminal of the transistor 321 and the other end coupled to a drain terminal of the transistor 322. The source terminal of the transistor 322 is coupled to the ground, and the abnormality detection signal XT is input to a gate terminal of the transistor 322.

When the temperature of the head unit 20 is equal to or lower than a predetermined value, since the voltage of the abnormality detection signal XT is equal to or greater than the threshold voltage of the transistor 322, conduction occurs between the drain terminal and the source terminal of the transistor 322, and since the voltage at the coupling point between the resistor 323 and the resistor 324 is lower than the threshold voltage of the transistor 321, conduction occurs between the source terminal and the drain terminal of the transistor 321. Therefore, a heater drive signal VHT is supplied from the positive terminal of the power supply circuit 90 to the positive terminal of the heater 260 via the terminal 23a, the transistor 321, and the terminal 23b, and current flows from the positive terminal to the negative terminal of the heater 260, causing the heater 260 to generate heat. Accordingly, the ink is heated.

The temperature of the head unit 20 rises due to the heat generated by the heater 260. Normally, the temperature of the head unit 20 fluctuates within a range equal to or lower than a predetermined value, but there are cases where the temperature of the head unit 20 becomes higher than the predetermined value due to some factor. In this case, the voltage of the abnormality detection signal XT becomes lower than the threshold voltage of the transistor 322, and a non-conductive state is created between the drain terminal and the source terminal of the transistor 322. Accordingly, the voltage at the coupling point between the resistor 323 and the resistor 324 becomes higher than the threshold voltage of the transistor 321, and a non-conductive state is created between the source terminal and the drain terminal of the transistor 321. Therefore, supply of the heater drive signal VHT to the positive terminal of the heater 260 is stopped, and the heat generation of the heater 260 gradually decreases. In this manner, the heater stop section 320 stops the operation of the heater 260 in response to the abnormality detection signal XT. Accordingly, the temperature of the head unit 20 is reduced and the concern of the head unit 20 breaking down is reduced.

Note that, unless the temperature of the head unit 20 becomes higher than a predetermined value, the transistors 321 and 322 maintain an on state in which conduction occurs between the source terminals and the drain terminals, and current continues to flow through the transistors 321 and 322. Therefore, in order to reduce power consumption, it is preferable that the on-resistance of the transistors 321 and 322 is low. In particular, since the smaller the on-resistance of the transistor 321 is, the higher the heat generation efficiency of the heater 260 is, it is preferable that the on-resistance of the transistor 321 is lower than the on-resistance of the transistor 322.

### 1-7. Mounting of Protection Circuit on Head Substrate

Next, mounting of the protection circuit 300 on the head substrate 23 will be described. FIG. 11 is a plan view of the upper surface of the head substrate 23 as viewed in the direction Z in FIG. 1. The head substrate 23 is, for example, a four-layer substrate including L1 to L4 layers, and FIG. 11 shows some of the wiring, electrodes, openings, and the like of the L1 layer. In FIG. 11, components mounted on the head substrate 23 and components coupled to the head substrate 23 are indicated by broken lines.

As shown in FIG. 11, a surface 400, which is the component mounting surface of the head substrate 23, is provided with a plurality of electrodes 401 to which a plurality of terminals of a connector 501 are respectively coupled, and a plurality of electrodes 402 to which a plurality of terminals of a connector 502 are respectively coupled. Further, on the surface 400 of the head substrate 23, wirings 411 to 419, electrodes 421 to 428, and openings 451 to 454 are provided. In addition, the surface 400 of the head substrate 23 is provided with a plurality of electrodes 431 to which a plurality of terminals of a flexible printed circuit (FPC) 511 inserted into the opening 451 are respectively coupled, and a plurality of electrodes 432 to which a plurality of terminals of an FPC 512 inserted into the opening 452 are respectively coupled. In addition, the surface 400 of the head substrate 23 is provided with a plurality of electrodes 441 to 444 to which a plurality of terminals of an FPC 513 inserted into the opening 453 are respectively coupled, and a plurality of electrodes 445 to 448 to which a plurality of terminals of an FPC 514 inserted into the opening 454 are respectively coupled.

A one-chip IC including a drive signal selection circuit 200a and a temperature detection circuit 230a is mounted on the FPC 511. Similarly, a one-chip IC including a drive signal selection circuit 200b and a temperature detection circuit 230b is mounted on the FPC 512. In addition, a heating element 260a and a thermistor 312a are mounted on the FPC 513. Similarly, a heating element 260b and a thermistor 312b are mounted on the FPC 514.

The wiring 411 is coupled to one of the plurality of electrodes 401 and the electrode 421. The wiring 411 is a drive signal propagation wiring through which a drive signal COMa input from the connector 501 propagates. The electrode 421 is coupled to the wiring 411 and one of the plurality of electrodes 431, and the drive signal COMa is input to the drive signal selection circuit 200a via the electrode 431.

The wiring 412 is coupled to one of the plurality of electrodes 401 and the electrode 422. The wiring 412 is a wiring through which a reference voltage signal VBSa input from the connector 501 propagates. The electrode 422 is coupled to the wiring 412 and another one of the plurality of electrodes 431, and the reference voltage signal VBSa is input to the drive signal selection circuit 200a via the electrode 431.

The wiring 413 is coupled to one of the plurality of electrodes 402 and the electrode 423. The wiring 413 is a drive signal propagation wiring through which a drive signal COMb input from the connector 502 propagates. The electrode 423 is coupled to the wiring 413 and one of the plurality of electrodes 432, and the drive signal COMb is input to the drive signal selection circuit 200b via the electrode 432.

The wiring 414 is coupled to the electrode 424. Moreover, the wiring 414 is coupled to one of the plurality of electrodes 402 via wirings provided in L2 to L4 layers (not shown). The wiring 414 is a wiring through which a reference voltage signal VBSb input from the connector 502 propagates. The electrode 424 is coupled to the wiring 414 and another one of the plurality of electrodes 432, and the reference voltage signal VBSb is input to the drive signal selection circuit 200b via the electrode 432.

The wiring 415 is coupled to one of the plurality of electrodes 401. The wiring 415 is coupled to the terminal 23a of the protection circuit 300 shown in FIG. 10 via wirings provided in L2 to L4 layers (not shown). The wiring 415 is a wiring through which a heater drive signal VHT input from the connector 501 propagates.

The wiring 419 is coupled to the electrode 425. The wiring 419 is coupled to the terminal 23b of the protection circuit 300 shown in FIG. 10 via wirings provided in L2 to L4 layers (not shown). The electrode 425 is coupled to the wiring 415 and the electrode 441. The electrode 441 is coupled to one end of the heating element 260a, and the other end of the heating element 260a is coupled to the electrode 442. The electrode 442 is coupled to the electrode 426. The electrodes 443 and 444 are coupled to both ends of the thermistor 312a.

The electrode 426 is coupled to the electrode 442 and a wiring 416. The wiring 416 is coupled to a wiring 417 via wirings provided in L2 to L4 layers (not shown). The wiring 417 is coupled to the electrode 427.

The electrode 427 is coupled to the wiring 417 and the electrode 445. The electrode 445 is coupled to one end of the heating element 260b, and the other end of the heating element 260b is coupled to the electrode 446. The electrode 446 is coupled to the electrode 428. The electrodes 447 and 448 are coupled to both ends of the thermistor 312b.

The electrode 428 is coupled to the electrode 446 and the wiring 418. The wiring 418 is coupled to the ground via wirings provided in L2 to L4 layers (not shown). The heating elements 260a and 260b are coupled in series between the terminal 23b of the protection circuit 300 and the ground, and the heating elements 260a and 260b form the heater 260. The wirings 415, 416, 417, 418, and 419 are heater wirings through which the heater drive signal VHT propagates.

Although not shown, a large number of wirings, electrodes, vias, and the like are provided on the surface 400 of the head substrate 23, and the area for disposing the protection circuit 300 is limited. Therefore, when the protection circuit 300 is realized as a digital circuit using an FPGA or the like, there is a concern that there is no area available for mounting on the surface 400 of the head substrate 23. Therefore, in the present embodiment, as shown in FIG. 10, the protection circuit 300 is realized as an analog circuit using the resistors 311, 323, and 324, the thermistor 312, and the transistors 321 and 322, and the resistors 311, 323, and 324, the thermistor 312, and the transistors 321 and 322 are each mounted in an analog manner on the surface 400 of the head substrate 23 as individual electronic components. In this manner, the protection circuit 300 is realized with a small number of electronic components, and therefore can be disposed in a small area on the surface 400 of the head substrate 23.

Incidentally, the method of driving the heater 260 differs depending on the model of the liquid ejecting apparatus 1, and depending on the driving method, the heater drive signal VHT may become a noise source for the head unit 20. The drive signals COMa and COMb are analog signals that control the ejection of ink and are susceptible to noise, and therefore it is preferable that the wirings 411 and 413 through which the drive signals COMa and COMb propagate are disposed away from the wirings 415, 416, 417, 418, and 419 through which the heater drive signal VHT propagates and the electrodes 425, 426, 427, 428, 441, 442, 445, and 446. Therefore, in the example of FIG. 11, there is an area A1 between the wiring 411 and the wirings 415, 416, and 419. Therefore, in order to effectively utilize this area A1, at least the heater stop section 320 of the protection circuit 300 is disposed in the area A1. That is, the heater stop section 320 is mounted between the wiring 411 which is the drive signal propagation wiring and the wirings 415, 416, and 419 which are heater wirings. Furthermore, the temperature abnormality detection section 310 may also be mounted between the wiring 411 and the wirings 415, 416, and 419.

The heater stop section 320 may be disposed in the area between the wiring 413 and the wirings 417 and 418. That is, the heater stop section 320 may be mounted between the wiring 413 which is the drive signal propagation wiring and the wirings 417 and 418 which are heater wirings. Furthermore, the temperature abnormality detection section 310 may also be mounted between the wiring 413 and the wirings 417 and 418.

However, a portion of the temperature abnormality detection section 310 may not be mounted between the drive signal propagation wiring and the heater wiring on the surface 400 of the head substrate 23. For example, the thermistor 312 may not be mounted between the drive signal propagation wiring and the heater wiring, and may be mounted on the surface of the L4 layer, which is the lower surface of the head substrate 23. Alternatively, in the temperature abnormality detection section 310, the thermistor 312 may be replaced with the thermistor 312a mounted on the FPC 513 or the thermistor 312b mounted on the FPC 514.

Note that the P-channel transistor 321 is an example of a “first transistor”, and the N-channel transistor 322 is an example of a “second transistor”. In addition, the resistor 323 is an example of a “first resistor”, and the resistor 324 is an example of a “second resistor”. Moreover, the positive terminal of the heater 260 is an example of a “first heater terminal”, and the negative terminal of the heater 260 is an example of a “second heater terminal”.

### 1-8. Effects

As described above, with the liquid ejecting apparatus 1 and the head unit 20 according to the first embodiment, in the protection circuit 300, when the temperature abnormality detection section 310 detects a temperature abnormality, the heater stop section 320 stops the operation of the heater 260, thereby reducing the concern of the head unit 20 breaking down due to a temperature abnormality. Furthermore, with the liquid ejecting apparatus 1 and the head unit 20 according to the first embodiment, on the head substrate 23, which is provided with wiring for a large number of signals such as drive signals COMa and COMb for driving a large number of piezoelectric elements 60 and on which a large number of electronic components are mounted, the heater stop section 320 is mounted in an analog manner, and can therefore be disposed even in a limited small area. In particular, the heater stop section 320 shown in FIG. 10 is realized with a small number of electronic components, and therefore, mounting in an analog manner is possible in a limited small area of the head substrate 23.

Furthermore, with the liquid ejecting apparatus 1 and the head unit 20 according to the first embodiment, the drive signal wiring through which the drive signals COMa and COMb, which are susceptible to noise, propagate is disposed away from the heater wiring through which the heater drive signal VHT, which can be a noise source, propagates, thereby making it possible to mount the heater stop section 320 by effectively utilizing the area A1 that occurs between the drive signal wiring and the heater wiring. Furthermore, with the liquid ejecting apparatus 1 and the head unit 20 according to the first embodiment, the influence of the heater drive signal VHT on the drive signals COMa and COMb is reduced, thereby improving the ink ejection accuracy.

### 2. Second Embodiment

In the following, for a second embodiment, components similar to those in the first embodiment are given the same symbols, and descriptions that overlap with the first embodiment are omitted or simplified, and the differences from the first embodiment are mainly described.

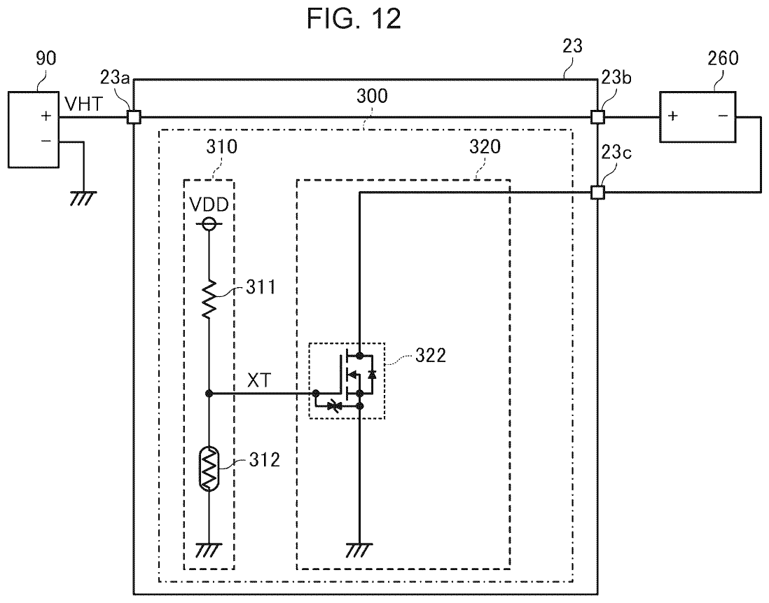

A liquid ejecting apparatus 1 according to the second embodiment differs from the liquid ejecting apparatus 1 according to the first embodiment in the configuration and the operation of a protection circuit 300 included in a head unit 20. FIG. 12 is a diagram showing an example of a configuration of the protection circuit 300 in the second embodiment. In FIG. 12, a power supply circuit 90, a head substrate 23, and a heater 260 are also shown.

As shown in FIG. 12, a head substrate 23 has terminals 23a, 23b, and 23c. The terminal 23a is coupled to a positive terminal of the power supply circuit 90 and is a power supply terminal to which a heater drive signal VHT for driving the heater 260 is input. The terminal 23b is a terminal that is coupled to a positive terminal of the heater 260. The terminal 23b is also coupled to the terminal 23a. Therefore, a positive terminal of the heater 260 is coupled to the terminal 23a via the terminal 23b. The terminal 23c is a terminal that is coupled to a negative terminal of the heater 260.

As shown in FIG. 12, the protection circuit 300 includes a temperature abnormality detection section 310 and a heater stop section 320. The temperature abnormality detection section 310 includes a resistor 311 and a thermistor 312, and its configuration and the operation are similar to those in FIG. 10, and thus description thereof will be omitted.

The heater stop section 320 includes an N-channel transistor 322. For example, the transistor 322 is an N-channel FET.

A drain terminal of the transistor 322 is coupled to the terminal 23c. Therefore, the drain terminal of the transistor 322 is coupled to the negative terminal of the heater 260 via the terminal 23c. A source terminal of the transistor 322 is coupled to ground. An abnormality detection signal XT is input to a gate terminal of the transistor 322.

When the temperature of the head unit 20 is equal to or lower than a predetermined value, the voltage of the abnormality detection signal XT is equal to or greater than the threshold voltage of the transistor 322. Therefore, conduction occurs between the drain terminal and the source terminal of the transistor 322 and the negative terminal of the heater 260 is coupled to ground. Therefore, a heater drive signal VHT is supplied from the positive terminal of the power supply circuit 90 to the positive terminal of the heater 260 via the terminals 23a and 23b, and current flows from the positive terminal to the negative terminal of the heater 260, causing the heater 260 to generate heat. Accordingly, the ink is heated.

On the other hand, when the temperature of the head unit 20 becomes higher than the predetermined value, the voltage of the abnormality detection signal XT becomes lower than the threshold voltage of the transistor 322, and a non-conductive state is created between the drain terminal and the source terminal of the transistor 322. Accordingly, the coupling between the negative terminal of the heater 260 and the ground is cut off, and no current flows through the heater 260, so that the heat generated by the heater 260 gradually decreases. In this manner, the heater stop section 320 stops the operation of the heater 260 in response to the abnormality detection signal XT. Accordingly, the temperature of the head unit 20 is reduced and the concern of the head unit 20 breaking down is reduced.

Note that, unless the temperature of the head unit 20 becomes higher than a predetermined value, the transistor 322 maintains an on state in which conduction occurs between the source terminals and the drain terminals, and current continues to flow through the transistor 322. Therefore, in order to reduce power consumption, it is preferable that the on-resistance of the transistor 322 is low.

A mounting example of the protection circuit 300 on the head substrate 23 in the second embodiment is similar to that shown in FIG. 11, and therefore is not shown. In the second embodiment, the protection circuit 300 is also realized as an analog circuit using the resistor 311, the thermistor 312, and the transistor 322, and the resistor 311, the thermistor 312, and the transistor 322 are each mounted in an analog manner on the surface 400 of the head substrate 23 as individual electronic components. In this way, the protection circuit 300 in the second embodiment is realized with even fewer electronic components than the protection circuit 300 in the first embodiment, and therefore can be disposed in a smaller area on the surface 400 of the head substrate 23.

In the second embodiment, similarly to the first embodiment, the heater stop section 320 is mounted between the wiring 411 which is the drive signal propagation wiring and the wirings 415, 416, and 419 which are heater wirings. Furthermore, the temperature abnormality detection section 310 may also be mounted between the wiring 411 and the wirings 415, 416, and 419. Alternatively, the heater stop section 320 may be mounted between the wiring 413 which is the drive signal propagation wiring and the wirings 417 and 418 which are heater wirings. Furthermore, the temperature abnormality detection section 310 may also be mounted between the wiring 413 and the wirings 417 and 418.

Other configurations and functions of the liquid ejecting apparatus 1 according to the second embodiment are similar to those of the liquid ejecting apparatus 1 according to the first embodiment, and thus description thereof will be omitted.

Note that, the positive terminal of the heater 260 is an example of a “first heater terminal”, and the negative terminal of the heater 260 is an example of a “second heater terminal”.

With the liquid ejecting apparatus 1 and the head unit 20 according to the second embodiment described above, the same effects as those of the liquid ejecting apparatus 1 and the head unit 20 according to the first embodiment can be obtained.

### 3. Third Embodiment

In the following, for a third embodiment, components similar to those in the first or second embodiment are given the same symbols, and descriptions that overlap with the first or second embodiment are omitted or simplified, and the differences from the first and second embodiments are mainly described.

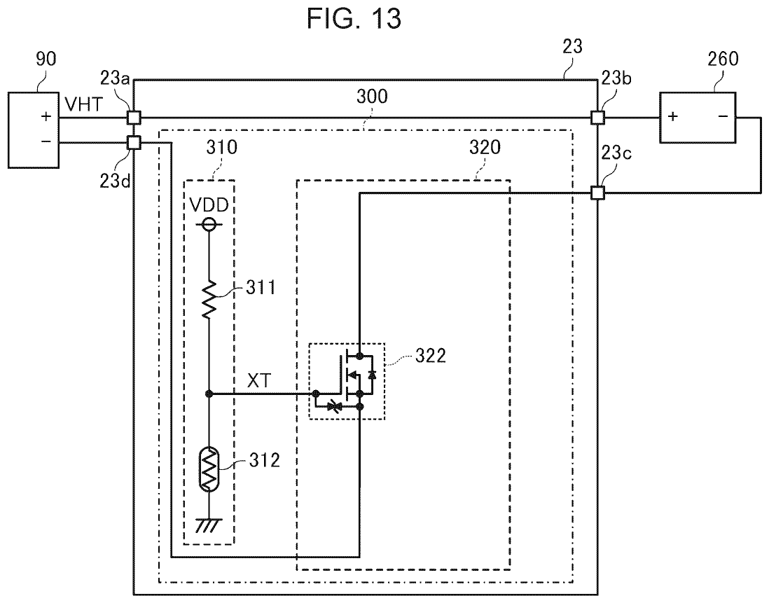

A liquid ejecting apparatus 1 according to the third embodiment differs from the liquid ejecting apparatus 1 according to the first embodiment or the second embodiment in the configuration and the operation of a protection circuit 300 included in a head unit 20. FIG. 13 is a diagram showing an example of a configuration of the protection circuit 300 in the third embodiment. In FIG. 13, a power supply circuit 90, a head substrate 23, and a heater 260 are also shown.

As shown in FIG. 13, the head substrate 23 has terminals 23a, 23b, 23c, and 23d. The terminal 23a is coupled to a positive terminal of the power supply circuit 90 and is a power supply terminal to which a heater drive signal VHT for driving the heater 260 is input. The terminal 23b is a terminal that is coupled to a positive terminal of the heater 260. The terminal 23b is also coupled to the terminal 23a. Therefore, a positive terminal of the heater 260 is coupled to the terminal 23a via the terminal 23b. The terminal 23c is a terminal that is coupled to a negative terminal of the heater 260. The terminal 23d is a power supply terminal coupled to a negative terminal of the power supply circuit 90.

As shown in FIG. 13, the protection circuit 300 includes a temperature abnormality detection section 310 and a heater stop section 320. The temperature abnormality detection section 310 includes a resistor 311 and a thermistor 312, and its configuration and the operation are similar to those in FIG. 10, and thus description thereof will be omitted.

The heater stop section 320 includes an N-channel transistor 322. For example, the transistor 322 is an N-channel FET.

A drain terminal of the transistor 322 is coupled to the terminal 23c. Therefore, the drain terminal of the transistor 322 is coupled to the negative terminal of the heater 260 via the terminal 23c. A source terminal of the transistor 322 is coupled to the terminal 23d. Therefore, the source terminal of the transistor 322 is coupled to the negative terminal of the power supply circuit 90 via the terminal 23d. An abnormality detection signal XT is input to a gate terminal of the transistor 322.

When the temperature of the head unit 20 is equal to or lower than a predetermined value, the voltage of the abnormality detection signal XT is equal to or greater than the threshold voltage of the transistor 322. Therefore, conduction occurs between the drain terminal and the source terminal of the transistor 322 and the negative terminal of the heater 260 is coupled to the negative terminal of the power supply circuit 90. Therefore, a heater drive signal VHT is supplied from the positive terminal of the power supply circuit 90 to the positive terminal of the heater 260 via the terminals 23a and 23b, and current flows from the positive terminal to the negative terminal of the heater 260, causing the heater 260 to generate heat. Accordingly, the ink is heated.

On the other hand, when the temperature of the head unit 20 becomes higher than the predetermined value, the voltage of the abnormality detection signal XT becomes lower than the threshold voltage of the transistor 322, and a non-conductive state is created between the drain terminal and the source terminal of the transistor 322. Accordingly, the coupling between the negative terminal of the heater 260 and the negative terminal of the power supply circuit 90 is cut off, and no current flows through the heater 260, so that the heat generated by the heater 260 gradually decreases. In this manner, the heater stop section 320 stops the operation of the heater 260 in response to the abnormality detection signal XT. Accordingly, the temperature of the head unit 20 is reduced and the concern of the head unit 20 breaking down is reduced.

Note that, unless the temperature of the head unit 20 becomes higher than a predetermined value, the transistor 322 maintains an on state in which conduction occurs between the source terminals and the drain terminals, and current continues to flow through the transistor 322. Therefore, in order to reduce power consumption, it is preferable that the on-resistance of the transistor 322 is low.

A mounting example of the protection circuit 300 on the head substrate 23 in the third embodiment is similar to that shown in FIG. 11, and therefore is not shown. In the third embodiment, the protection circuit 300 is also realized as an analog circuit using the resistor 311, the thermistor 312, and the transistor 322, and the resistor 311, the thermistor 312, and the transistor 322 are each mounted in an analog manner on the surface 400 of the head substrate 23 as individual electronic components. In this way, the protection circuit 300 in the third embodiment is realized with even fewer electronic components than the protection circuit 300 in the first embodiment, and therefore can be disposed in a smaller area on the surface 400 of the head substrate 23.

In the third embodiment, similarly to the first embodiment, the heater stop section 320 is mounted between the wiring 411 which is the drive signal propagation wiring and the wirings 415, 416, and 419 which are heater wirings. Furthermore, the temperature abnormality detection section 310 may also be mounted between the wiring 411 and the wirings 415, 416, and 419. Alternatively, the heater stop section 320 may be mounted between the wiring 413 which is the drive signal propagation wiring and the wirings 417 and 418 which are heater wirings. Furthermore, the temperature abnormality detection section 310 may also be mounted between the wiring 413 and the wirings 417 and 418.

Other configurations and functions of the liquid ejecting apparatus 1 according to the third embodiment are similar to those of the liquid ejecting apparatus 1 according to the first or second embodiment, and thus description thereof will be omitted.

Note that the terminal 23a is an example of a “first power supply terminal”, and the terminal 23d is an example of a “second power supply terminal”. Moreover, the positive terminal of the heater 260 is an example of a “first heater terminal”, and the negative terminal of the heater 260 is an example of a “second heater terminal”.

With the liquid ejecting apparatus 1 and the head unit 20 according to the third embodiment described above, the same effects as those of the liquid ejecting apparatus 1 and the head unit 20 according to the first embodiment can be obtained.

### 4. Fourth Embodiment

In the following, for a fourth embodiment, components similar to those in any of the first to third embodiments are given the same symbols, and descriptions that overlap with any of the first to third embodiments are omitted or simplified, and the differences from any of the first to third embodiments are mainly described.

A liquid ejecting apparatus 1 according to the fourth embodiment differs from the liquid ejecting apparatus 1 according to the first to third embodiments in the configuration and the operation of a protection circuit 300 included in a head unit 20. In the protection circuit 300 in the first to third embodiments, the temperature abnormality detection section 310 detects a temperature abnormality using the thermistor 312, but in the protection circuit 300 in the fourth embodiment, a temperature abnormality detection section 310 detects a temperature abnormality based on a temperature abnormality signal XHOT.

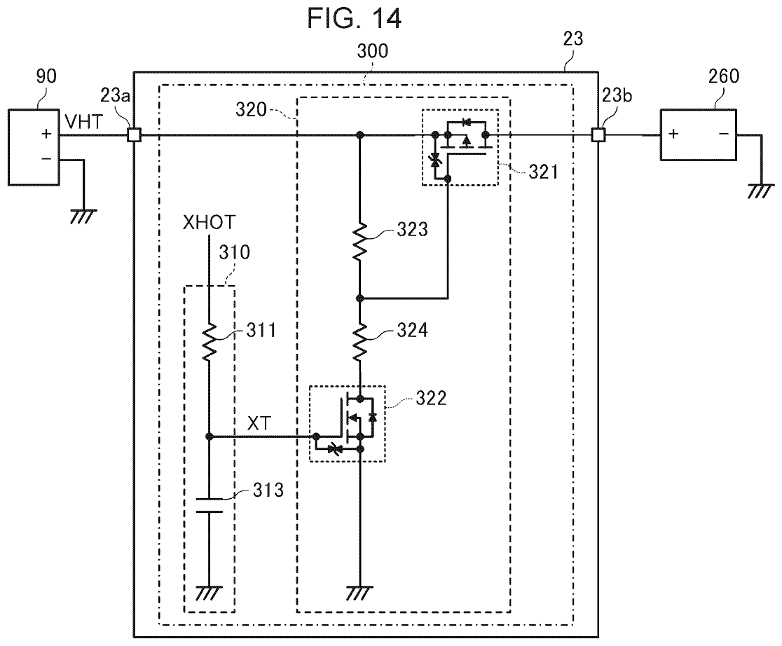

FIG. 14 is a diagram showing an example of a configuration of the protection circuit 300 in the fourth embodiment. In the protection circuit 300 shown in FIG. 14, the temperature abnormality detection section 310 includes a resistor 311 and a capacitor 313.

The resistor 311 has one end to which the temperature abnormality signal XHOT is input, and the other end coupled to one end of the capacitor 313. The other end of the capacitor 313 is coupled to ground. A signal at a coupling point where the other end of the resistor 311 and one end of the capacitor 313 are coupled is output to a heater stop section 320 as an abnormality detection signal XT. When the temperature of a print head 22 is normal, the temperature abnormality signal XHOT is at an H level of a voltage VDD, and the abnormality detection signal XT also becomes the voltage VDD. On the other hand, when the temperature of the print head 22 is abnormal, the temperature abnormality signal XHOT is at an L level of a ground potential, and the abnormality detection signal XT also becomes the ground potential.

In the example of FIG. 14, the configuration of the heater stop section 320 and the coupling relationship between a power supply circuit 90, a head substrate 23, and a heater 260 is the same as that in FIG. 10. When the abnormality detection signal XT is at the H level, conduction occurs between a drain terminal and a source terminal of a transistor 322, and conduction occurs between a source terminal and a drain terminal of a transistor 321. Therefore, a heater drive signal VHT is supplied from the positive terminal of the power supply circuit 90 to the positive terminal of the heater 260 via the terminal 23a, the transistor 321, and the terminal 23b, and current flows from the positive terminal to the negative terminal of the heater 260, causing the heater 260 to generate heat. Accordingly, the ink is heated.

On the other hand, when the abnormality detection signal XT is at the L level, a non-conductive state is created between the drain terminal and the source terminal of the transistor 322, and a non-conductive state is created between the source terminal and the drain terminal of the transistor 321. Therefore, supply of the heater drive signal VHT to the positive terminal of the heater 260 is stopped, and the heat generation of the heater 260 gradually decreases. In this manner, the heater stop section 320 stops the operation of the heater 260 in response to the abnormality detection signal XT. Accordingly, the temperature of the head unit 20 is reduced and the concern of the head unit 20 breaking down is reduced.

Note that in FIG. 14, the transistor 321 is an example of a “first transistor”, and the N-channel transistor 322 is an example of a “second transistor”. In addition, the resistor 323 is an example of a “first resistor”, and the resistor 324 is an example of a “second resistor”. Moreover, the positive terminal of the heater 260 is an example of a “first heater terminal”, and the negative terminal of the heater 260 is an example of a “second heater terminal”.

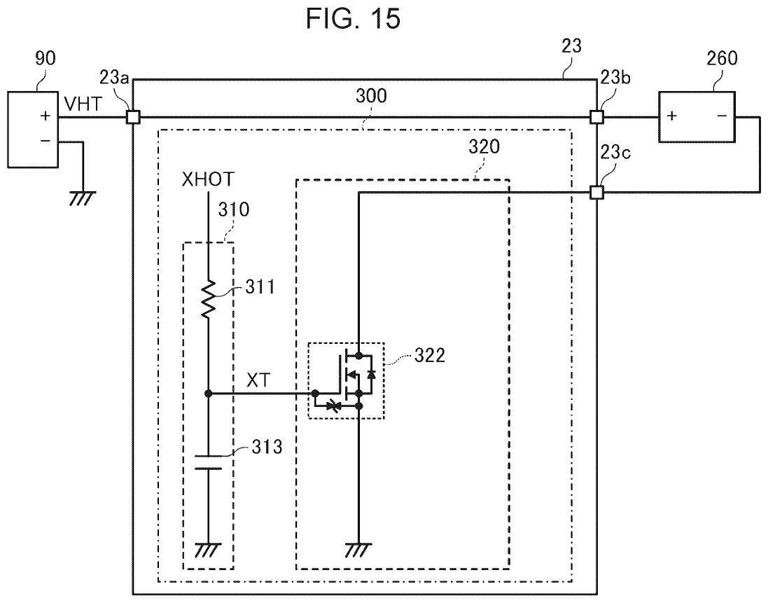

FIG. 15 is a diagram showing another example of the configuration of the protection circuit 300 in the fourth embodiment. In the protection circuit 300 shown in FIG. 15, the configuration of the temperature abnormality detection section 310 is the same as that in FIG. 14, the configuration of the heater stop section 320 is the same as that in FIG. 12, and the coupling relationship between the power supply circuit 90, the head substrate 23, and the heater 260 is the same as that in FIG. 12.

When the abnormality detection signal XT is at the H level, conduction occurs between the drain terminal and the source terminal of the transistor 322, and the negative terminal of the heater 260 is coupled to the ground. Therefore, a heater drive signal VHT is supplied from the positive terminal of the power supply circuit 90 to the positive terminal of the heater 260 via the terminals 23a and 23b, and current flows from the positive terminal to the negative terminal of the heater 260, causing the heater 260 to generate heat. Accordingly, the ink is heated.

On the other hand, when the abnormality detection signal XT is at the L level, a non-conductive state is created between the drain terminal and the source terminal of the transistor 322. Accordingly, the coupling between the negative terminal of the heater 260 and the ground is cut off, and no current flows through the heater 260, so that the heat generated by the heater 260 gradually decreases. In this manner, the heater stop section 320 stops the operation of the heater 260 in response to the abnormality detection signal XT. Accordingly, the temperature of the head unit 20 is reduced and the concern of the head unit 20 breaking down is reduced.

Note that, in FIG. 15, the positive terminal of the heater 260 is an example of a “first heater terminal”, and the negative terminal of the heater 260 is an example of a “second heater terminal”.

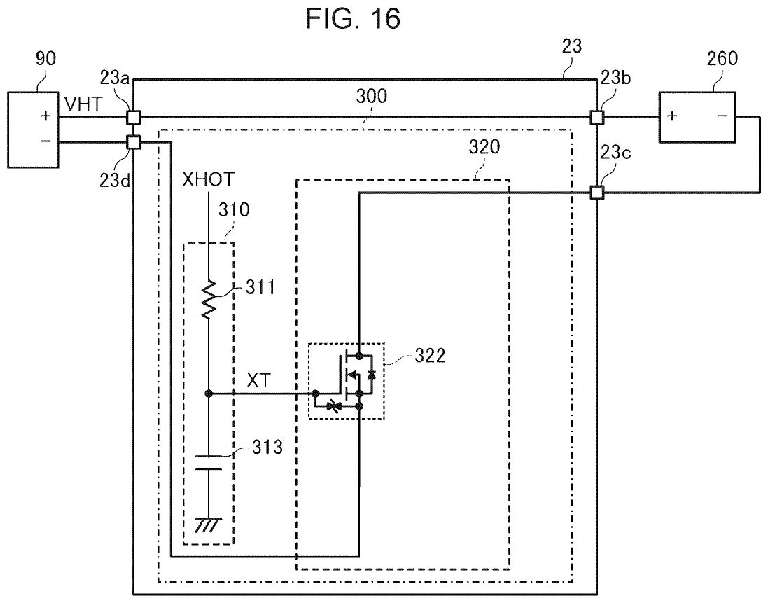

FIG. 16 is a diagram showing another example of a configuration of the protection circuit 300 in the fourth embodiment. In the protection circuit 300 shown in FIG. 16, the configuration of the temperature abnormality detection section 310 is the same as that in FIG. 14, the configuration of the heater stop section 320 is the same as that in FIG. 13, and the coupling relationship between the power supply circuit 90, the head substrate 23, and the heater 260 is the same as that in FIG. 13.

When the abnormality detection signal XT is at the H level, conduction occurs between the drain terminal and the source terminal of the transistor 322, and the negative terminal of the heater 260 is coupled to the negative terminal of the power supply circuit 90. Therefore, a heater drive signal VHT is supplied from the positive terminal of the power supply circuit 90 to the positive terminal of the heater 260 via the terminals 23a and 23b, and current flows from the positive terminal to the negative terminal of the heater 260, causing the heater 260 to generate heat. Accordingly, the ink is heated.

On the other hand, when the abnormality detection signal XT is at the L level, a non-conductive state is created between the drain terminal and the source terminal of the transistor 322. Accordingly, the coupling between the negative terminal of the heater 260 and the negative terminal of the power supply circuit 90 is cut off, and no current flows through the heater 260, so that the heat generated by the heater 260 gradually decreases. In this manner, the heater stop section 320 stops the operation of the heater 260 in response to the abnormality detection signal XT. Accordingly, the temperature of the head unit 20 is reduced and the concern of the head unit 20 breaking down is reduced.

Note that, in FIG. 16, the terminal 23a is an example of a “first power supply terminal”, and the terminal 23d is an example of a “second power supply terminal”. Moreover, the positive terminal of the heater 260 is an example of a “first heater terminal”, and the negative terminal of the heater 260 is an example of a “second heater terminal”.

A mounting example of the protection circuit 300 on the head substrate 23 in the fourth embodiment is similar to that shown in FIG. 11, and therefore is not shown. In the fourth embodiment, the protection circuit 300 shown in FIG. 14 is realized as an analog circuit using the resistors 311, 323, and 324, the capacitor 313, and the transistors 321 and 322, and the resistors 311, 323, and 324, the capacitor 313, and the transistors 321 and 322 are each mounted in an analog manner on the surface 400 of the head substrate 23 as individual electronic components. In addition, the protection circuit 300 shown in FIG. 15 or FIG. 16 is also realized as an analog circuit using the resistor 311, the capacitor 313, and the transistor 322, and the resistor 311, the capacitor 313, and the transistor 322 are each mounted in an analog manner on the surface 400 of the head substrate 23 as individual electronic components. In this manner, the protection circuit 300 in the fourth embodiment is realized with a small number of electronic components, and therefore can be disposed in a small area on the surface 400 of the head substrate 23.

In the fourth embodiment, similarly to the first to third embodiments, the heater stop section 320 is mounted between the wiring 411 which is the drive signal propagation wiring and the wirings 415, 416, and 419 which are heater wirings. Furthermore, the temperature abnormality detection section 310 may also be mounted between the wiring 411 and the wirings 415, 416, and 419. Alternatively, the heater stop section 320 may be mounted between the wiring 413 which is the drive signal propagation wiring and the wirings 417 and 418 which are heater wirings. Furthermore, the temperature abnormality detection section 310 may also be mounted between the wiring 413 and the wirings 417 and 418.

Other configurations and functions of the liquid ejecting apparatus 1 according to the fourth embodiment are similar to those of the liquid ejecting apparatus 1 according to the first to third embodiments, and thus description thereof will be omitted.

With the liquid ejecting apparatus 1 and the head unit 20 according to the fourth embodiment described above, the same effects as those of the liquid ejecting apparatus 1 and the head unit 20 according to any of the first to third embodiments can be obtained.

### 5. Modification Example

The present disclosure is not limited to the present embodiment, and various modifications can be made within the scope of the spirit of the present disclosure.

For example, in each of the above embodiments, the control unit 10 includes two drive circuits 50, but the number of drive circuits 50 included in the control unit 10 may be one or three or more. Similarly, the print head 22 includes two liquid ejecting modules 21, but the number of liquid ejecting modules 21 included in the print head 22 may be one or three or more.

In addition, in each of the above embodiments, the liquid ejecting apparatus 1 has been described as a so-called serial type ink jet printer in which the liquid ejecting module 21 that ejects ink is mounted on the carriage 24 and printing is performed by the carriage 24 reciprocating over the medium P. However, the liquid ejecting apparatus 1 may be a so-called line type ink jet printer in which the liquid ejecting module 21 is disposed in a row in the width direction of the medium P and printing is performed by transporting the medium P.

The embodiments have been described above, but the present disclosure is not limited to these embodiments and can be carried out in various modes without departing from the scope of the present disclosure. For example, it is possible to combine the above embodiments as appropriate.

The present disclosure includes substantially the same configurations as the configurations described in the embodiments, for example, configurations having the same functions, methods, and results, or configurations having the same objects and effects. Further, the present disclosure includes configurations in which non-essential portions of the configurations described in the embodiments are replaced. Moreover, the present disclosure includes configurations that achieve the same effect as the configurations described in the embodiments or configurations that can achieve the same object. Further, the present disclosure includes configurations in which known techniques are added to the configurations described in the embodiment.

The following contents are derived from the above embodiments.

According to an aspect, there is provided a head unit including: a head having a piezoelectric element which is displaced in response to application of a drive signal, and including an ejecting section which ejects ink in response to the displacement of the piezoelectric element; a heater that heats the ink; a temperature abnormality detection section that detects a temperature abnormality and outputs an abnormality detection signal; a heater stop section that stops an operation of the heater in response to the abnormality detection signal; and a head substrate coupled to the head, in which the heater stop section is mounted in an analog manner on the head substrate.

With this head unit, when the temperature abnormality detection section detects a temperature abnormality, the heater stop section stops the operation of the heater, thereby reducing the concern of breakdown due to a temperature abnormality. Furthermore, with this head unit, on the head substrate, which is provided with wiring for a large number of signals such as drive signals for driving piezoelectric elements and on which a large number of electronic components are mounted, the heater stop section is mounted in an analog manner, and can therefore be disposed even in a limited small area.

In the head unit according to the aspect, the head substrate may have a drive signal propagation wiring through which the drive signal propagates, and a heater wiring through which a heater drive signal for driving the heater propagates, and the heater stop section may be mounted between the drive signal propagation wiring and the heater wiring.

Furthermore, with this head unit, the drive signal wiring through which the drive signals, which are susceptible to noise, propagate is disposed away from the heater wiring through which the heater drive signal, which can be a noise source, propagates, thereby making it possible to mount the heater stop section by effectively utilizing the area that occurs between the drive signal wiring and the heater wiring. Furthermore, with this head unit, the influence of the heater drive signal on the drive signal is reduced, thereby improving the ink ejection accuracy.

In the head unit according to the aspect, the head substrate may have a power supply terminal to which a heater drive signal for driving the heater is input, the heater may have a first heater terminal and a second heater terminal, the second heater terminal may be coupled to ground, the heater stop section may include a first transistor that is a P-channel type, a second transistor that is an N-channel type, a first resistor, and a second resistor, a drain terminal of the first transistor may be coupled to the first heater terminal, a source terminal of the first transistor may be coupled to the power supply terminal, the first resistor may have one end coupled to the source terminal of the first transistor and another end coupled to a gate terminal of the first transistor, the second resistor may have one end coupled to the gate terminal of the first transistor and another end coupled to a drain terminal of the second transistor, a source terminal of the second transistor may be coupled to ground, and the abnormality detection signal may be input to a gate terminal of the second transistor.

With this head unit, the heater stop section is realized with a small number of electronic components, and therefore, mounting in an analog manner is possible in a limited small area of the head substrate.

In the head unit according to the aspect, the head substrate may have a power supply terminal to which a heater drive signal for driving the heater is input, the heater may have a first heater terminal and a second heater terminal, the first heater terminal may be coupled to the power supply terminal, the heater stop section may include a transistor that is an N-channel type, a drain terminal of the transistor may be coupled to the second heater terminal, a source terminal of the transistor may be coupled to ground, and the abnormality detection signal may be input to a gate terminal of the transistor.

With this head unit, the heater stop section is realized with a small number of electronic components, and therefore, mounting in an analog manner is possible in a limited small area of the head substrate.

In the head unit according to the aspect, the head substrate may have a first power supply terminal which is coupled to a positive terminal of a power supply circuit and to which a heater drive signal for driving the heater is input, and a second power supply terminal coupled to a negative terminal of the power supply circuit, the heater may have a first heater terminal and a second heater terminal, the first heater terminal may be coupled to the first power supply terminal, the heater stop section may include a transistor that is an N-channel type, a drain terminal of the transistor may be coupled to the second heater terminal, a source terminal of the transistor may be coupled to the second power supply terminal, and the abnormality detection signal may be input to a gate terminal of the transistor.

With this head unit, the heater stop section is realized with a small number of electronic components, and therefore, mounting in an analog manner is possible in a limited small area of the head substrate.

In the head unit according to the aspect, the first transistor may have a lower on-resistance than the second transistor.

In this head unit, when the temperature abnormality detection section detects no temperature abnormality, conduction occurs between the source terminal and the drain terminal of the first transistor, and thus a heater drive signal is supplied to the heater. With this head unit, the on-resistance of the first transistor is small, and therefore the current flowing through the heater is large, and the heat generation efficiency can be improved.

According to an aspect, there is provided a liquid ejecting apparatus including: a head unit; and a power supply circuit, in which the head unit includes a head having a piezoelectric element which is displaced in response to application of a drive signal, and including an ejecting section which ejects ink in response to the displacement of the piezoelectric element, a heater that heats the ink, a temperature abnormality detection section that detects a temperature abnormality and outputs an abnormality detection signal, a heater stop section that stops an operation of the heater in response to the abnormality detection signal, and a head substrate coupled to the head, the power supply circuit outputs a heater drive signal for driving the heater, and the heater stop section is mounted in an analog manner on the head substrate.

In the liquid ejecting apparatus according to the aspect, the head substrate may have a drive signal propagation wiring through which the drive signal propagates, and a heater wiring through which the heater drive signal propagates, and the heater stop section may be mounted between the drive signal propagation wiring and the heater wiring.

In the liquid ejecting apparatus according to the aspect, the head substrate may have a power supply terminal to which the heater drive signal is input, the heater may have a first heater terminal and a second heater terminal, the second heater terminal may be coupled to ground, the heater stop section may include a first transistor that is a P-channel type, a second transistor that is an N-channel type, a first resistor, and a second resistor, a drain terminal of the first transistor may be coupled to the first heater terminal, a source terminal of the first transistor may be coupled to the power supply terminal, the first resistor may have one end coupled to the source terminal of the first transistor and another end coupled to a gate terminal of the first transistor, the second resistor may have one end coupled to the gate terminal of the first transistor and another end coupled to a drain terminal of the second transistor, a source terminal of the second transistor may be coupled to ground, and the abnormality detection signal may be input to a gate terminal of the second transistor.

In the liquid ejecting apparatus according to the aspect, the head substrate may have a power supply terminal to which the heater drive signal is input, the heater may have a first heater terminal and a second heater terminal, the first heater terminal may be coupled to the power supply terminal, the heater stop section may include a transistor that is an N-channel type, a drain terminal of the transistor may be coupled to the second heater terminal, a source terminal of the transistor may be coupled to ground, and the abnormality detection signal may be input to a gate terminal of the transistor.

In the liquid ejecting apparatus according to the aspect, the head substrate may have a first power supply terminal which is coupled to a positive terminal of the power supply circuit and to which the heater drive signal is input, and a second power supply terminal coupled to a negative terminal of the power supply circuit, the heater may have a first heater terminal and a second heater terminal, the first heater terminal may be coupled to the first power supply terminal, the heater stop section may include a transistor that is an N-channel type, a drain terminal of the transistor may be coupled to the second heater terminal, a source terminal of the transistor may be coupled to the second power supply terminal, and the abnormality detection signal may be input to a gate terminal of the transistor.

In the liquid ejecting apparatus according to the aspect, the first transistor may have a lower on-resistance than the second transistor.

What is claimed is:

1. A head unit comprising:
a head having a piezoelectric element which is displaced in response to application of a drive signal, and including an ejecting section which ejects ink in response to the displacement of the piezoelectric element;
a heater that heats the ink;
a temperature abnormality detection section that detects a temperature abnormality and outputs an abnormality detection signal;
a heater stop section that stops an operation of the heater in response to the abnormality detection signal; and
a head substrate coupled to the head, wherein
the heater stop section is mounted in an analog manner on the head substrate.

2. The head unit according to claim 1, wherein
the head substrate has
a drive signal propagation wiring through which the drive signal propagates, and
a heater wiring through which a heater drive signal for driving the heater propagates, and
the heater stop section is mounted between the drive signal propagation wiring and the heater wiring.

3. The head unit according to claim 1, wherein
the head substrate has a power supply terminal to which a heater drive signal for driving the heater is input,
the heater has a first heater terminal and a second the second heater terminal is coupled to ground,
the heater stop section includes
a first transistor that is a P-channel type,
a second transistor that is an N-channel type,
a first resistor, and
a second resistor,
a drain terminal of the first transistor is coupled to the first heater terminal,
a source terminal of the first transistor is coupled to the power supply terminal,
the first resistor has one end coupled to the source terminal of the first transistor and another end coupled to a gate terminal of the first transistor,
the second resistor has one end coupled to the gate terminal of the first transistor and another end coupled to a drain terminal of the second transistor,
a source terminal of the second transistor is coupled to ground, and
the abnormality detection signal is input to a gate terminal of the second transistor.

4. The head unit according to claim 1, wherein
the head substrate has a power supply terminal to which a heater drive signal for driving the heater is input,
the heater has a first heater terminal and a second heater terminal,
the first heater terminal is coupled to the power supply terminal,
the heater stop section includes a transistor that is an N-channel type,
a drain terminal of the transistor is coupled to the second heater terminal,
a source terminal of the transistor is coupled to ground, and
the abnormality detection signal is input to a gate terminal of the transistor.

5. The head unit according to claim 1, wherein
the head substrate has a first power supply terminal which is coupled to a positive terminal of a power supply circuit and to which a heater drive signal for driving the heater is input, and a second power supply terminal coupled to a negative terminal of the power supply circuit,
the heater has a first heater terminal and a second heater terminal,
the first heater terminal is coupled to the first power supply terminal,
the heater stop section includes a transistor that is an N-channel type,
a drain terminal of the transistor is coupled to the second heater terminal,
a source terminal of the transistor is coupled to the second power supply terminal, and
the abnormality detection signal is input to a gate terminal of the transistor.

6. The head unit according to claim 3, wherein
the first transistor has a lower on-resistance than the second transistor.

7. A liquid ejecting apparatus comprising:
a head unit; and
a power supply circuit, wherein
the head unit includes
a head having a piezoelectric element which is displaced in response to application of a drive signal, and including an ejecting section which ejects ink in response to the displacement of the piezoelectric element,
a heater that heats the ink,
a temperature abnormality detection section that detects a temperature abnormality and outputs an abnormality detection signal,
a heater stop section that stops an operation of the heater in response to the abnormality detection signal, and
a head substrate coupled to the head,
the power supply circuit outputs a heater drive signal for driving the heater, and
the heater stop section is mounted in an analog manner on the head substrate.

8. The liquid ejecting apparatus according to claim 7, wherein
the head substrate has
a drive signal propagation wiring through which the drive signal propagates, and
a heater wiring through which the heater drive signal propagates, and
the heater stop section is mounted between the drive signal propagation wiring and the heater wiring.

9. The liquid ejecting apparatus according to claim 7, wherein
the head substrate has a power supply terminal to which the heater drive signal is input,
the heater has a first heater terminal and a second heater terminal,
the second heater terminal is coupled to ground,
the heater stop section includes
a first transistor that is a P-channel type,
a second transistor that is an N-channel type,
a first resistor, and
a second resistor,
a drain terminal of the first transistor is coupled to the first heater terminal,
a source terminal of the first transistor is coupled to the power supply terminal,
the first resistor has one end coupled to the source terminal of the first transistor and another end coupled to a gate terminal of the first transistor,
the second resistor has one end coupled to the gate terminal of the first transistor and another end coupled to a drain terminal of the second transistor,
a source terminal of the second transistor is coupled to ground, and
the abnormality detection signal is input to a gate terminal of the second transistor.

10. The liquid ejecting apparatus according to claim 7, wherein
the head substrate has a power supply terminal to which the heater drive signal is input,
the heater has a first heater terminal and a second heater terminal,
the first heater terminal is coupled to the power supply terminal,
the heater stop section includes a transistor that is an N-channel type,
a drain terminal of the transistor is coupled to the second heater terminal,
a source terminal of the transistor is coupled to ground, and
the abnormality detection signal is input to a gate terminal of the transistor.

11. The liquid ejecting apparatus according to claim 7, wherein
the head substrate has a first power supply terminal which is coupled to a positive terminal of the power supply circuit and to which the heater drive signal is input, and a second power supply terminal coupled to a negative terminal of the power supply circuit,
the heater has a first heater terminal and a second heater terminal,
the first heater terminal is coupled to the first power supply terminal,
the heater stop section includes a transistor that is an N-channel type,
a drain terminal of the transistor is coupled to the second heater terminal,
a source terminal of the transistor is coupled to the second power supply terminal, and
the abnormality detection signal is input to a gate terminal of the transistor.

12. The liquid ejecting apparatus according to claim 9, wherein
the first transistor has a lower on-resistance than the second transistor.
